(19) United States
(12) Patent Application Publication
(10) Pub. No.: US 2003/0184861 A1
(43) Pub. Date: Oct. 2, 2003

(54) Optical isolator

(75) Inventor: Masanori Ikari, Gunma (JP)

Correspondence Address: HOGAN & HARTSON L.L.P., 500 S. GRAND AVENUE, SUITE 1900, LOS ANGELES, CA, 90071-2611, US

(73) Assignee: SHIN-ETSU CHEMICAL CO., LTD.

(21) Appl. No.: 10/400,766

(22) Filed: Mar. 27, 2003

(30) Foreign Application Priority Data
Mar. 27, 2002 (JP) 2002-89396

(51) Int. Cl. G02B 5/30

(52) U.S. Cl. 359/484; 359/494; 359/499; 372/703

(57) ABSTRACT

An optical isolator comprising at least a first birefringent polarization element, a 45° faraday rotator, a first ½ waveplate, a second ½ waveplate, and a second birefringent polarization element arranged in this order, wherein the first and second ½ waveplates reciprocally rotate. polarization planes of signal light at 45° in total while canceling out wavelength dispersion of retardation, and there is provided a single-stage type optical isolator of low cost having small coupling loss in the forward direction and having good isolation characteristics in the backward direction.

### BACKGROUND OF THE INVENTION

1. Field of the Invention

The present invention salutes to a polarization independent optical isolator incorporated into an optical communication system.

2. Related Art

An optical isolator is an optical device that signal light is transmitted to a forward direction, but light returning to the backward direction is shielded, and it is incorporated into a plural number of modules in an optical communication system. For example, there has been used a polarization dependent optical isolator, which is placed in the vicinity of an exit end of an LD (Laser Diode) to transmit oscillating laser light and to shield light returning to the backward direction for continuously oscillating signal light stably, or a polarization independent optical isolator to prevent light amplified in a optical fiber amplifier from returning to the backward direction.

Recently, the development of the optical communication system has been shifted from a trunk line system to a metro system. Chances in user of a semiconductor optical amplifier as well as an optical fiber amplifier used conventionally in the trunk line system have been increased. In this case, an optical coupling between an optical fiber and the semiconductor optical amplifier is often conducted by a single lens, and since cost performance takes priority over gain performance, each component has been required to be used for general purpose and reasonable prices.

Accordingly, regarding the structure of the optical isolator usable in a single lens coupling system, a single-stage type optical isolator using birefringent plate crystals and an optical rotatory element is disclosed in Japanese patent Laid-open application No. 54-159245, for example. As shown in FIGS. 3 and 4, in an isolator 20 having such a structure, signal light transmitted from an optical fiber 14 through a lens 12 is separated by a first birefringent polarization element 1 made of birefringent plate crystal into two orthogonal components of ordinary light and extraordinary light.

After that, the optical axis is adjusted so that polarization planes of both signal light components are rotated non-reciprocally at 45° in a 45° faraday rotator 2, and these polarization planes are rotated reciprocally at 45° in a ½ waveplate 6 serving as an optical rotatory element, and then ordinary light and extraordinary light are inputted and transmitted to a second birefringent polarization element 5 made of birefringent plate crystal as extraordinary light and ordinary light, respectively. Accordingly, both of the signal light components have the same exit position after transmitted to an optical isolator, namely, the signal light components are not separated, and thus the signal light components exit to an optical fiber 15 through a lens 13.

On the other hand, after light returning to the backward direction is transmitted to a second birefringent polarization element 5, and separated into ordinary light and extraordinary light, when both of the signal components are transmitted to a ½ waveplate 6 and a 45° faraday rotator 2, these polarization planes are rotated at 90° with respect to the polarization plane of the signal light propagating to a forward direction. Accordingly, since ordinary light and extraordinary light are inputted and transmitted to the first birefringent polarization element 1 as ordinary light and extraordinary light, respectively, the signal light components of light returning to the backward direction after transmitted to the first birefringent polarization element 1 are further separated and no longer coupled. By this manner, this structure functions as an optical isolator. Accordingly, oven if this isolator is inserted into the middle of a single lens optically-coupling system, namely, inserted between an optical fiber and a lens or between the lens and a semiconductor optical amplifier, the focus of the signal light is not separated, and therefore the signal light can be transmitted and the light returning to the backward direction can be shielded without the generation of excessive coupling loss.

Meanwhile, this optical isolator comprises optical rotatory elements. Generally, wavelength dispersion and temperature dependency of retardation of an optical rotatory element are not small, and this causes the degradation of isolation characteristics iii the entire optical isolator. Accordingly, countermeasures such that the aforementioned optical isolator units are arranged double in series to obtain higher isolation or the like have been taken to meet the requirement. However, regarding a semiconductor optical amplifier, since greater importance is attached to cost performance than to isolation performance, the structure that optical isolator units are arranged double in series can not cope with the requirement because of high cost. Therefore, it is necessary to develop an optical isolator having improved isolation charactoristics and the same exit position even though it is a single-stage type optical isolator.

### SUMMARY OF THE INVENTION

The present invention was accomplished to solve above problems, and its object is to provide a single stage type optical isolator of low-cost having a small coupling loss in the forward direction and having good isolation characteristics in the backward direction.

In order to accomplish the above object, the present invention provides an optical isolator comparing at least a first birefringent polarization element, a 45° faraday rotator, a first ½ waveplate, a second ½ waveplate, and a second birefringent polarization element arranged in this order, wherein the first and second ½ waveplates reciprocally rule polarization planes of signal light at 45° in total while canceling out wavelength dispersion of retardation.

As described above, although, conventionally, one ½ waveplate reciprocally rotates a polarization plane of signal light, the present invention comprises the first ½ waveplate and the second ½ waveplate to reciprocally rotate polarization planes of signal light At 45° in total while canceling out wavelength dispersion of retardation. Such a structure copes with wavelength dispersion of retardation of the ½ waveplates, and thus there can be provided an optical isolator having a small coupling loss in the forward direction and having good isolation characteristics in the backward direction even though it is a single-stage type optical isolator of low-cost.

In this case, it is preferable that each component of optical axes in the first and second birefringent polarization elements perpendicular to the forward direction of signal light is parallel or perpendicular to each other, and an angle between each optical axis in the first and second birefringent polarization elements and the forward direction of the signal light is made within 0° to 90°.

Since each optical axis of the first and second birefringent polarization elements is set as described above, there can be provided a low-cost optical isolator of which birefringent polarization elements can be easily processed.

In this case, it is preferable that both of the first and second birefringent polarization elements arc made of the same birefringent material.

As described above, if both of the first and second birefringent polarization elements are made of the same birefringent material, single crystals for the birefringent polarization elements can be grown by one process and produced at low cost.

As explained above, according to the present invention, there can be provided a single-stage type optical isolator of low-cost having a .small coupling loss in the forward direction and having good isolation characteristics in the backward direction.

### BRIEF EXPLANATION OF THE DRAWINGS

FIG. 1 is an explanatory view showing one example of the structure of the optical isolator according to the present invention.

FIG. 2 is an explanatory view showing the state of light propagating in the optical isolator according to the present invention.

FIG. 3 is an explanatory view showing one example of the structure of a conventional optical insulator .

FIG. 4 is an explanatory view showing the state of light propagating of d conventional optical isolator.

FIG. 5 is a graph showing isolation characteristics or the optical isolator in Example.

FIG. 6 is a graph showing isolation characteristics of the optical isolator in Comparative Example.

### PREFERRED EMBODIMENTS OF THE INVENTION

Hereinafter, embodiments of the present invention will be explained in detail. However, the present invention is not limited thereto.

The present inventors have studied diligently to obtain an optical isolator such that isolation characteristics are improved and each exit position agrees even though it is a single-stage type optical isolator. As the result, they found that the above subject matter can be accomplished by the isolator such that two ½ waveplates are disposed and these ½ waveplate reciprocally rotate each polarization plane or signal light at 45° in total while canceling out wavelength dispersion of retardation. Then they completed the present invention.

In a conventional single-stage type optical isolator comprising birefringent plate crystal, and a optical rotatory element as disclosed in Japanese Patent Laid-open application No. 54-159245, a ½ waveplate made of crystal is generally used. In the structure, a slow axis (optical axis) of the crystal is disposed with an inclination direction of ±22.5 or ±67.50 with respect to an incident polarized wave, and a signal light component incident to a ½ waveplate goes half on Poincare sphere around this slow axis and exits. At this moment, only a light in a center wavelength rotates just ½ wavelength, namely, 180° , a light in a shorter wavelength rotates 180° or more, and a light in a longer wavelength does not rotate up to 180° before it exits. These shorter and longer wavelength components become elliptically polarized waves, and since an elliptically polarized wave component which was ordinary light (extraordinary light) in the first birefringent plate crystal is also transmitted to a second birefringent plate crystal as ordinary light (extraordinary light), an exit position is not agreed with a coupling position of the signal light, and thus coupling loan occurs.

Also, in the case of the light returning to the backward direction, an opposite phenomenon to the above occurs. Namely, since an elliptically polarized wave which was ordinary light (extraordinary light) in the second birefringent plate crystal is transmitted to the first birefringent plate crystals as extraordinary light (ordinary light), an exit position of the light returning to the backward direction is agreed with a coupling position of an optical fiber, and thus isolation characteristics are decreased remarkably.

On the contrary, in order to solve the above problems, the optical isolator having the structure of the present invention comprises two ½ waveplates to reciprocally rotate the light twice every ½ wavelength. Namely, the shorter wavelength component, which has already rotated on Poincare sphere at 180°+α° around the. optical axis after firstly transmitted to the ½ waveplate, is secondly transmitted to the ½ waveplate under the polarization state (where the state is shifted from an equator of Poincare sphere to a latitude direction at −α°) to rotate on Poincare sphere at 180°+α° around the optical axis of the second ½ waveplate, and finally, it represents as −α°+180°+α°180°, the state is agreed with the equator of Poincare sphere, so that the component does not have an elliptical component.

In the same way, the longer wavelength component, which is rotated on Poincare sphere at 180°−β° around the optical axis after firstly transmitted to the ½ waveplate, is secondly transmitted to the ½ waveplate under the polarization state (where the state is shifted from an equator of Poincare sphere to a latitude direction at +β°) to rotate on Poincare sphere at 180°−β° around the optical axis of the second ½ waveplate, and finally, it represents as −β°+180°+β°=180°, the state is agreed with the equator of Poincare sphere, so that it does not have an elliptical component.

As described above, in the whole wavelength range, the polarized component after transmitted to two ½ waveplates does not have an elliptical component. Accordingly, there can be provided a single-stage type optical isolator having small excess loss (coupling loss) in the forward direction and having good isolation characteristics in the backward direction.

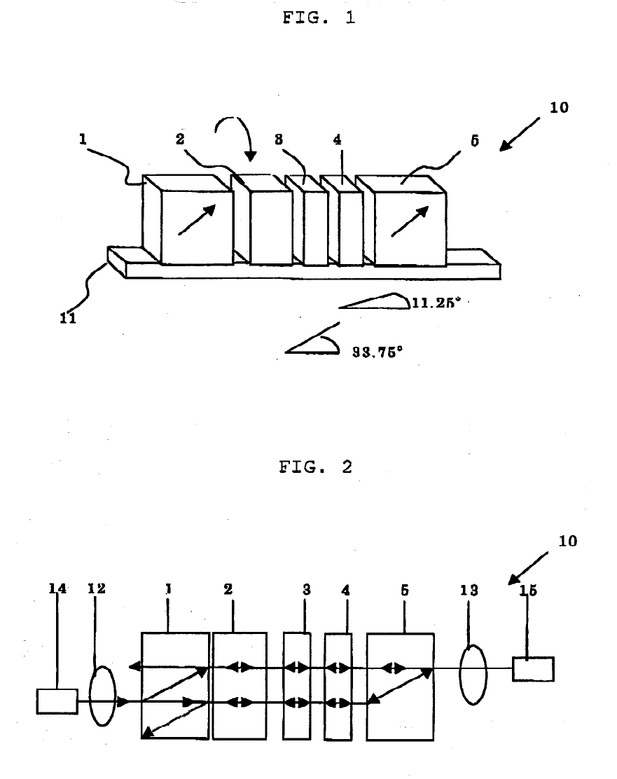

FIG. 1 is an explanatory view showing one example of the structure of the optical isolator according to the present invention. In an optical isolator 10 of the present invention, at least a first birefringent polarization element 1, a 45n faraday rotator 2, a first ½ waveplate 3, a second ½ waveplate 4, and a second birefringent polarization element 5 are arranged in this order on a base plate 11. As described above, the optical isolator of the present invention is characterized by using two ½ waveplates. The optical axes of these first and second ½ waveplate 3 and 4 are set so as to rotate polarization planes of signal light at 45° in total, while canceling out wavelength dispersion of retardation.

In the example shown in FIG. 1, the first ½ waveplate 3 is processed so that its optical axis is inclined at 33.75° with respect to the side in contact with the base plate 11. Also, the second ½ waveplate 4 is processed so that its optimal axis is inclined at 11.25° with respect to the side in contact with the base plate 11. After the signal light is transmitted to thus structured first and second waveplates 3 and 4, the wavelength dispersion of retardation is cancelled out and its polarization plane is rotated at 45° in total according to the above described principle. In this case, these ½ waveplates are made of crystal or the like.

And each component of the optical axes of the first and second birefringent polarization element 1 and 5 perpendicular to the forward direction of the signal light is parallel or perpendicular to each other, and an angle between each optical axis in the first and second birefringent polarization elements and the forward direction of the signal. light is made within 0° to 90°. If each optical axis is set as described above, 10 is away to be processed or the like. in the example of FIG. 1, optical axis components of both birefringent polarization elements 1 and 5 perpendicular to the forward direction of the signal light are parallel to each other, and the angle between each optical axis of both birefringent polarization elements 1 and 5 and the forward direction of the signal light is made 45°.

These birefringent polarization elements 1 and 5 are made of such as YVO₄ single crystal. In this case, it is preferable that both the first and second birefringent polarization elements 1 and 5 are made of the same birefringent material. If they arc made of the same birefringent material, a single crystal for the birefringent polarization element can be grown by one process and processed at low coat.

Also, a 45° faraday rotator can be made of such as bismuth-containing raro-carth iron garnet single crystal or the like.

Such an optical isolator 10 functions as follows. First, an shown FIG. 2, after signal light is transmitted from an optical fiber 14 through a lens 12, the signal light is Separated into two orthoqonal components of ordinary light and extraordinary light by a first birefringent polarization clement 1, polarization planes of both signal light component are rotated non-reciprocally at 45° in a faraday rotator 2.

Next, the optical axis of the first ½ waveplate 3 is inclined at 33.75° with respect to the side where the first ½ waveplate 3 comes in contact with the base plate 11, and thereby each Signal light component of ordinary and extraordinary lights exiting from the first ½ waveplate 3 are rotated at 22.5°. Moreover, the optical axis of the second ½ waveplate 4 is inclined at 11.25° with respect to the aide where the second ½ waveplate 4 comes in contact with the base plate 11, and thereby each signal light component of ordinary and extraordinary lights exiling from the second ½ waveplate 4 are further rotated at 22.5°. Accordingly, each polarization plane of the signal lights transmitted to the first and second ½ waveplates 3 and 4 is rotated at 45° in total. On the other hand, as aforementioned, the optical isolator 10 of the present invention comprises two ½ waveplates 3 and 4 to rotate the light twice reciprocally on Poincare sphere every ½ wavelength, and thereby, the polarized component does not have an elliptical component in the whole wavelength range. Therefore, regarding the signal lights incident on the following second ½ birefringent polarization element 5, all ordinary light and 8 extraordinary light are inputted and transmitted thereto an ordinary light and extraordinary light, respectively. in this case, since each exit position is completely agreed with each other, excess loss in the forward digestion becomes small.

On the other hand, after light returning to the backward direction is transmitted to a second birefringent polarization element 5 and separated into ordinary light and extraordinary light, each polarization plane of the signal lights is rotated reciprocally at 45° in total by a second and first ½ waveplates 4 and 3 while canceling out wavelength dispersion of retardation as in the forward direction. In this case as well, each polarized component of the signal lights does not have an elliptical component. Therefore, regarding the polarized components of the signal light rotated non-reciprocally at 45° by a 45° faraday rotator 2, all ordinary light and all extraordinary light are inputted and transmitted as ordinary light and extraordinary light, respectively, by a first birefringent polarization element 1. Then each signal light component is further separated, the returning light is not agreed with a coupling position of a lens 12 and an optical fiber 14, and thus good isolation characteristics can be realized.

### EXAMPLE

Hereinafter, the present invention will be explained in reference to examples, but the present invention is not limited thereto.

### (Example)

An optical isolator of the present invention as shown FIG. 1 was produced. Two plate-type birefringent crystal plates having sizes of 1.3×1.3×0.9 t used as birefringent polarization elements were cut out from a YVO₄ single crystal grown by CZ (Czochralski) method. At that point, the birefringent polarization elements were processed so as to incline each optical axis at 45° with respect to a normal of light incident and exit surfaces of the Signal light, and cut out so that each projection component vector of each optical axis with respect to these optical surfaces was parallel to one side of 1.3×1.3 of the plate-type birefringent crystal plate. Moreover, antireflection coating against air was applied on the light incident and exit surfaces of the signal light of each birefringent polarization element.

Next, a faraday rotator having sides of 1.3×1.3 was cut out fruit a bismuth-containing rare-earth iron garnet single crystal grown by LPE (Liquid-Phase opitaxy) method. At that point, the faraday rotator was processed to have the thickness so that polarization of the light having a wavelength of 1550 nm is rotated at 45° after transmitted to the faraday rotator, and antireflection coating against air was applied on light incident and exit surfaces of the signal light of the faraday rotator.

Additionally, two kinds of zero order ½ waveplates made of crystal were processed to have sides of 1.3×1.3×0.091L. At that point, the two kinds of the ½ waveplates were processed to incline optical axes at 33.75° and 11.25°, respectively with respect to one side of 1.3×1.3, and antireflection coating against air was applied on its light incident and exit surfaces.

These elements were arranged an shown in FIG. 1 that a first birefringent polarization element 1, a 45° faraday rotator 2, a first ½ waveplate 3, a second ½ waveplate 4 and a second birefringent polarization element 5 were bonded on A molded base plate 11 made of epoxy resin. Finally, a cylindrical magnet made of SmCo was bonded to the out side of that assembly unit so as to surround the unit, and thus an optical isolator 10 was completed.

Wavelength dependence of isolation characteristics of that optical isolator was measured by inserting the optical isolator into a collimator of 10 mm span connected with 83437A BROADBAND LIGHT SOURCE manufactured by Agilent Technology and MS59030A/MS9701C OPTICAL SPECTRUM ANALYZER manufactured by Anritsu. At that point, its temperature dependence was measured at three temperatures of 0° C., 35°C., and 70° C.

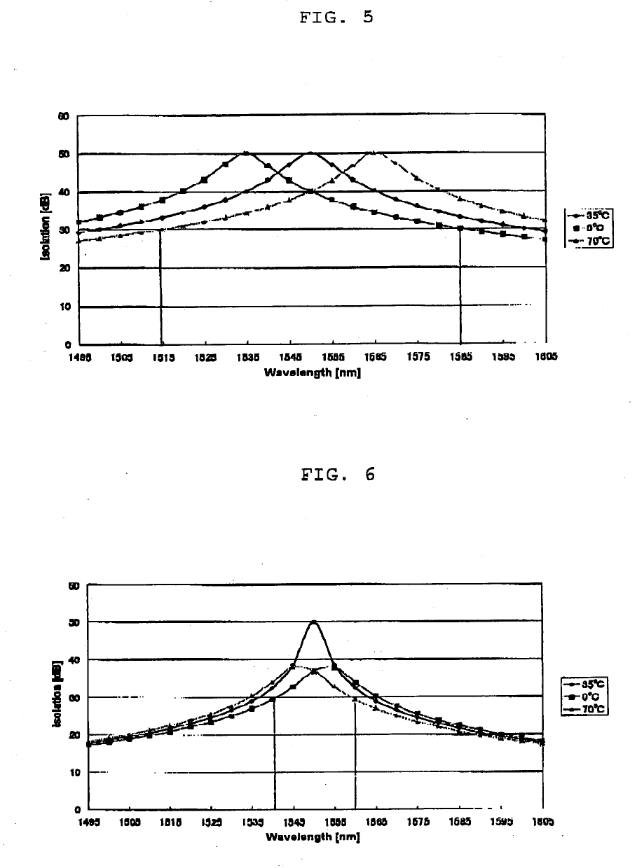

The result is shown in FIG. 5. It shows the good result that the bandwidth of isolation over 30 dB in the backward direction was 70 nm in the whole temperature range of 0-7° C.

(Comparative Example)

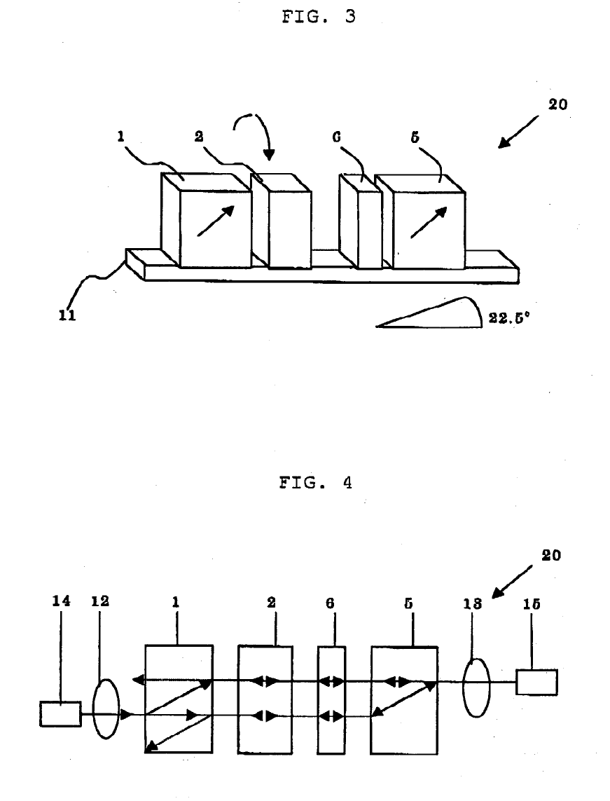

A conventional optical isolator as shown in FIG. 3 was produced. As in the example, a birefringent polarization element and a 45° faraday rotator were made. In the comparative example, only one kind of 112 waveplate made of crystal was processed to have sides of 1.3×1.3 ×0.091L. At that point, the 2 waveplate was processed to incline its optical axis at 22.50 with respect to one side of 1.3×1.3, and antireflection coating against air was applied on its light incident and exit surfaces of the signal light.

These elements were arranged as shown in FIG. 3 that a first birefringent polarization element 1, a 45° faraday rotator 2, a ½ waveplate 6, and a second birefringent polarization element 5 were bonded on a molded base plate 11 made of epoxy resin. Finally, a cylindrical magnet made of SmCo was bonded to the out side of the assembly unit so as to Surround the unit, and thus an optical isolator 20 was completed.

As in the example, wavelength dependence or isolation caracteristics of that optical isolator was measured by inserting the optical isolator into a collimator of 10 mm span connected with 83437A BROADBAND LIGHT SCOURCE manufactured by Agilent Technology and MS9030A/MS9701C OPTICAL SPECTRUM ANALYZER manufactured by Aniritsu. At that point, its temperatures dependence was measured at three temperatures of 0° C., 35° C., and 70° C.

The result is shown in FIG. 6. It shows the unsatisfactory result that the bandwidth of isolation over 30 dB in the backward direction was so narrow as 18 nm in the whole temperature range of 0°-70° C. in view of the above results, it was confirmed that the isolation characteristic of the optical isolation in the example (present invention) is better than that in the comparative (conventional) example.

The present invention is not limited to the embodiments described above. The above-described embodiments are mere examples used those having the substantially same structure as that described in the appended claims and providing the similar functions and advantages and included in the scope of the present invention.

For example, in the aforementioned embodiment, YVO₄ single crystal is used for plate-type birefringent crystal plates. However, other uniaxial birefringent single crystals such as rutile can also be used, namely, the material of the plate-type birefringent crystal plates is not limited thereto particularly. Moreover, the optical isolator of the present invention can be made by combining such optical elements as an additional lens or polarization element with optical elements such as a ½ waveplate in the aforementioned embodiment, and such a case is also included in the scope of the present invention.

What is claimed is:

1. An Optical isolator comprising at least a first birefringent: polarization element, a 45° faraday rotator, a first ½ waveplate, a second ½ waveplate, and a second birefringent polarization element arranged in this order, wherein the first and second ½ waveplates reciprocally rotate polarization planes of signal light at 45° in total while canceling out wavelength dispersion of retardation.

2. The optical isolator according to claim 1, wherein each component of optical axes in the first and second birefringent polarization elements perpendicular to a forward direction or signal light is parallel or perpendicular to each other, and an angle between each optical axis in the first and second birefringent polarization elements and a forward direction of the signal light is made within 0° to 90°.

3. The optical isolator according to claim 1, wherein both the first and second birefringent polarization elements are made of the same birefringent material.

4. Tile optical isolator according to claim 2, wherein both the first and second birefringent polarization elements are made of the same birefringent material.
